(19) United States
(12) Patent Application Publication
(10) Pub. No.: US 2009/0173002 A1
(43) Pub. Date: Jul. 9, 2009

(54) TRANSPLANTING METHOD AND APPARATUS

(76) Inventor: Clark P. Plihal, Shelton, NE (US)

Correspondence Address: VINCENT L. CARNEY LAW OFFICE, P.O. BOX 80836, LINCOLN, NE, 68501-0836, US

(21) Appl. No.: 12/343,084

(22) Filed: Dec. 23, 2008

Related U.S. Application Data
(63) Continuation-in-part of application No. 11/195,104, filed on Aug. 1, 2005.

(51) Int. Cl. A01G 9/02; A01G 23/02; A01G 23/04

(52) U.S. Cl. 47/66.3; 47/66.7; 47/73; 47/66.1; 47/74

(57) ABSTRACT

A plant is grown to maturity in a transplant container and transplanted into a recipient's container. The transplant container has side walls that can be easily detached from the bottom after the transplant container has been placed into the recipient's container above growing media. After the side walls have been removed, growing media is added to a level above the roots. The bottom of the transplant container is easily penetrated by the roots of the plant and is left in the recipient's container with the plant.

### RELATED CASES

This application is a continuation-in-part application of U.S. patent application Ser. No. 11/195,104 to Clark Plihal filed Aug. 1, 2005, for REMOVABLE BOTTOM TRANSPLANTING CONTAINER.

### BACKGROUND OF THE INVENTION

This invention relates to apparatus and methods for transplanting.

Containers are known for growing plants that are intended to be transplanted. Some of these containers are intended only for starting plants before they are transferred to a field. Others are intended to control the growth of the roots of the plants so that when they are transplanted, the roots will not interfere with other construction such as sidewalks or the like. Such containers frequently have parts that are designed to be easily removed and other parts remain with the plant after transplanting. Typically, the parts that remain with the plant are constructed to permit the plant roots to grow through the parts.

These containers and techniques for transplanting are not well adapted for one common purpose. That purpose is for a gardener that wishes to purchase a fully grown plant in a container from a nursery, greenhouse or the like and transplant it into the gardener's own container. For this purpose, the containers must be inexpensive to make and transport to the greenhouse or nursery and must be able to be quickly and easily assembled at the nursery or greenhouse. To be inexpensive, it must be constructed of inexpensive materials and must be shaped to permit easy stacking for shipment such as flat or with parts that can be packed one into the other for shipment. Moreover the assembled container must be sturdy enough to grow a mature plant and permit easy transplanting into the customers container.

### SUMMARY OF THE INVENTION

Accordingly, it is an object of the invention to provide novel methods and containers for transplanting plants.

It is a further object of the invention to provide novel methods and apparatuses for transplanting a plant grown in one location such as a nursery or greenhouse into another container at another location.

It is a still further object of the invention to provide a transplanting container that is quick and easy to assemble at a greenhouse or nursery.

It is a still further object of the invention to provide a container for transplanting that is economical to make.

It is a still further object of the invention to provide a container for transplanting that is economical to ship.

It is a still further object of the invention to provide a method and apparatus that permits easy and quick transplanting from a container in which the plant has been grown to another container.

It is a still further object of the invention to provide a container for transplanting that is readily decomposable and biodegradable.

It is a still further object of the invention to provide a technique for transplanting that reduces non-biodegradable aspects of transplanting.

In accordance with the above and further objects of the invention, mature plants are transplanted to a selected container from a root retaining container and the surplus parts of the root retaining container are removed. The root retaining container includes a side wall and a bottom. The surplus parts are removed after the root retaining container has been placed in the selected container. In one embodiment, the root retaining container includes a strip having end sections that connect together to form a continuous side wall and separate to permit easy removal of the side wall. The bottom is removable from the side wall. The surplus parts are removed by disconnecting the end sections that are connected together and removing the side wall from the bottom after the root retaining container has been placed in the selected container. The mature plant is left in the selected container. In an alternative embodiment, at least some surplus parts of the container are formed of plant-compatible biodegradable material, whereby the side wall biodegrades without causing root girding. The biodegradable material does not degrade in less than 120 days and degrades in less than one season. In another embodiment, the bottom is detached from the side wall before the first roots are covered with growing media.

To reduce transportation costs, the component parts of a plurality of stackable first containers are shipped to a second location and assembled as needed. The surplus parts and root compatible parts may be folded to be flat for easy shipment. A plurality of surplus parts fit one into the other and root compatible parts fit one into the other in some embodiments.

This method and apparatus has several advantages, such as for example: (1) they permit the gardener to easily purchase a mature plant and easily transplant it into a selected container; (2) they are inexpensive; and (3) they use parts that can be easily folded or fitted one into the other for inexpensive shipping and yet be quickly assembled into containers by the green house or nursery.

### BRIEF DESCRIPTION OF THE DRAWINGS

The above noted and other features of the invention will be better understood from the following detailed description when considered together with the accompanying drawings in which:

FIG. 1 is a flow diagram of a process for transplanting;

FIG. 2 is an exploded perspective view of a root retaining container useful in the process of FIG. 1;

FIG. 3 is a perspective view of a second embodiment of side wall taken from the bottom;

FIG. 4 is a perspective view of the embodiment of FIG. 3 taken from the side and top;

FIG. 5 is a perspective view of the embodiment of FIG. 3 taken directly from the top;

FIG. 6 is a perspective view of a root compatible bottom;

FIG. 7 is a perspective view looking from the bottom at a root retaining container having a side wall as shown in FIG. 5 and a root compatible bottom as shown in FIG. 6;

FIG. 8 is a perspective view looking downwardly into the root retaining container to see a penetrable or biodegradable root compatible part that overlies a spatial part;

FIG. 9 is a perspective view looking from the bottom of the spatial root compatible part and the container side wall which may be assembled to form a container in accordance with the invention;

FIG. 10 is a perspective view looking from the top of another embodiment of spatial root compatible part and the container side wall;

FIG. 11 is a plan view of an embodiment of spatial bottom flattened for shipment;

FIG. 12 is a top view of an embodiment of side wall with the ends disconnected and with the side wall flattened for shipment;

FIG. 13 is a diagrammatic side view illustrating the insertion of a root retaining container into a recipient's larger container as one stage of the transplanting process;

FIG. 14 is a diagrammatic side view illustrating the removal of the side wall of the root retaining container as a step in the transplanting;

FIG. 15 is a diagrammatic view of a person filling the recipient's container after the root retaining container without the side wall has been placed in it; and

FIG. 16 is a diagrammatic view showing the possible growth of a plant in the recipient's container after transplanting.

### DETAILED DESCRIPTION

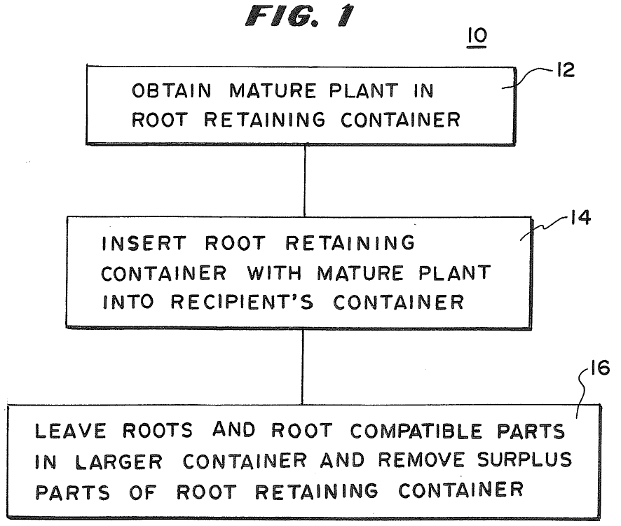

In FIG. 1, there is shown a flow diagram 10 of a process for transplanting comprising the step 12 of obtaining a mature plant in a root retaining container, the step 14 of inserting the root retaining container with a mature plant into recipients container and the step 16 of leaving the roots and the root compatible parts of the root retaining container in a larger container and removing surplus parts of the root retaining container. In this specification, the words “mature plant” shall mean a plant that is fully grown or grown to the extent desired by the person buying or otherwise obtaining a plant. For example, it may be a flower basket fully developed and arranged to provide the appearance desired. The words “root retaining container” shall mean a container for plants that has provisions for permitting root growth in at least a part of the container without the root girding or being forced to grow in a circle or extending in an undesirable large distance outside of the container. The language “root compatible parts of the container” means parts of the container that permit roots to grow through or beyond the parts.

Generally, this process is a method by which plants such as flower baskets may be grown and sold to a recipient to put in the recipient's container or containers (at times herein the recipient's container will refer to a selected container to indicate it is general to the transferring of mature plants from a container from which they are grown to another container and may not be necessarily the container of a purchaser from a greenhouse). Usually the mature plant is grown in the greenhouse root retaining container.

In the preferred embodiment of this invention, the “root compatible part” will be a root compatible bottom. In this specification, the language “root compatible bottom” means a bottom of a container that permits roots to grow through or beyond the bottom of the container. It would include a plant-compatible biodegradable bottom. “Plant-compatible biodegradable” in this specification means that the part degrades naturally at a rate that permits growth of the plant. For example, side walls of a container that degrade within 120 days may, under some circumstances and with some plants, avoid root girding by degrading sufficiently before additional space is needed for root growth so that the roots may grow beyond them. The root compatible parts of the container may be a root compatible side wall which is a side wall of the container that permits roots to grow through or beyond the side wall or may be a root compatible bottom which is the bottom of the container that permits roots to grow through or beyond the bottom of the container. Surplus parts of the root retaining container are the parts of the container that are not desirable in the finished plant nor serve a necessary function with the plant after the plant is transplanted into the recipient's container. Another form of root compatible side wall or bottom wall or compatible parts of the container in addition to plant-compatible biodegradable parts are parts such as a side wall or bottom that includes one or more opening or openings through which the roots may grow. This form of root compatible part is referred to from time to time in this specification as spatial root compatible parts or root compatible side walls or a root compatible bottom.

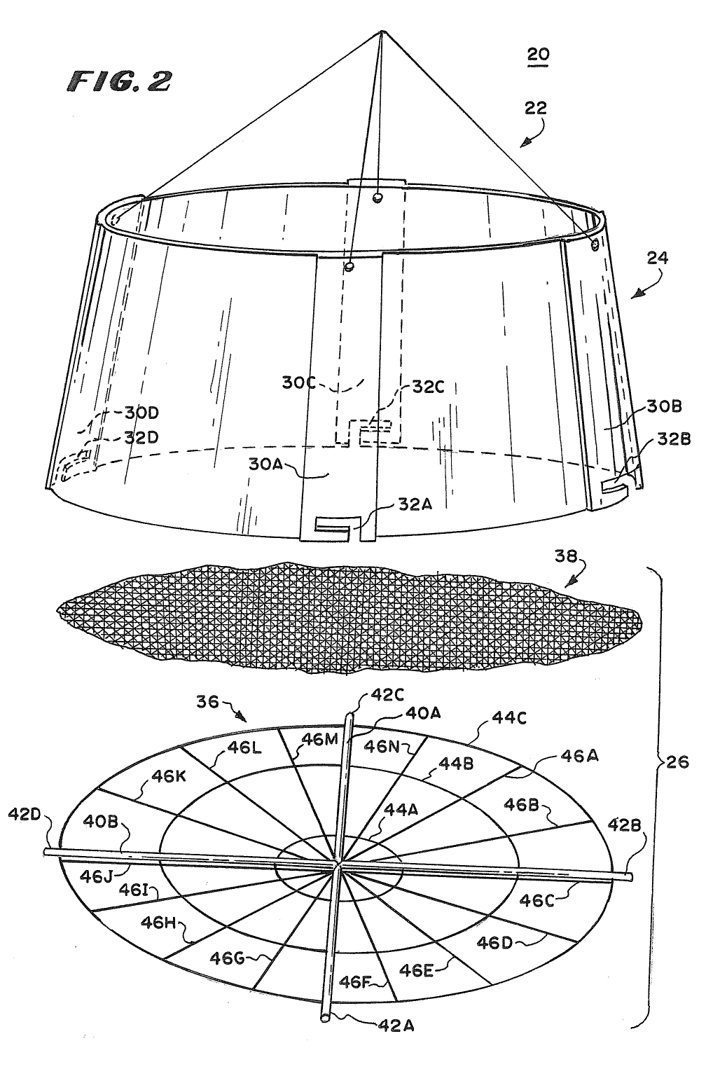

In FIG. 2, there is shown an exploded perspective view of a container 20 having a hanger 22, a side wall 24, and a bottom 26. In this embodiment of container, the hanger 22 includes flexible members attached to the top of the side wall 24 such as through eyelets and is adapted to hang the container. However, plants may be grown to maturity in containers which do not hang at all but rest on a flat surface, or other means for hanging the container may be used such as a solid member engaging the wall at one end. In the embodiment of FIG. 2, the side wall 24 is plastic and durable. In the preferred embodiment, the side wall 24 has a height of five inches and a thickness of approximately one-sixteenth of an inch. The top diameter is one quarter inch smaller than the bottom diameter allowing the side wall 24 to be stacked partly one inside of the other for purposes of shipping. In other embodiments described hereinafter, the side wall and other parts that are not already flat may be folded flat to be stackable. In this specification, “stackable” means at least two parts may be placed together to reduce the volume of the combination to less than the sum of the volumes of the two parts. For example, the two or more parts may fit one inside of the other if they are open or they may be folded flat and fit one on the other.

To mount a removable bottom 26 to the container 20, the side wall 24 include thickened portions 30A-30D. These portions 30A-30D are one-eighth of an inch thick in the preferred embodiment and have inverted L-shaped slots or notches 32A-32D cut into them. The container bottom 26 includes a spatial root compatible part 36 and a penetrable or a biodegradable part 38. A “penetrable part” in this specification means a part through which roots may grow because of their lack of strength. In the embodiment of FIG. 2, the penetrable part 38 may be fabric intended to rest upon the spatial root compatible part 36 to hold the growing medium while the plant is being grown to maturity. In the preferred embodiment, it is burlap or other fabric but it may be paper or some other biodegradable material. It is supported in place by the spatial root compatible part 36.

The spatial root compatible part 36 includes two sturdy cross members 40A and 40B which are cylindrical studs connected at their center and radiating outwardly to a length that is slightly greater than the diameter of the side wall 24 at the notches 32A-32D. The extending ends shown at 42A-42D are sized to fit within the notches 32A-32D and extend beyond them so that they form supporting points on the horizontal portions of the inverted L-shaped slots 32A-32D. To provide further support for the penetrable or biodegradable root compatible part 38, a web shaped configuration is connected to the supports 40A and 40B and consists of three concentric circles of wire or other material 44A, 44B and 44C spaced apart and mounted to the supports 40A and 40B. A plurality of wires such as those shown at 46A-46M radiate from the center to provide further support.

With this arrangement, the greenhouse operator or other grower may insert the spatial root compatible part 36 into the side wall 24 by moving the tubular stud supports or cross members 40A and 40B upwardly into the vertical portions of inverted L-shaped notches 32A-32D and then rotating it into the horizontal portions to hold the two together. The penetrable or biodegradable root compatible parts 38 may be placed on top within the side wall 24. Growing medium may then be inserted and a plant may be grown to maturity using the container 20 as a hanging basket. At maturity, it may be delivered to a recipient who may want to transfer it into a larger container of his or her own.

In the embodiment of FIG. 2, the bottom or base 26 is detached from the side wall 24 while the side wall forms a continuous polyhedron with no ends to be separated. Because the top of the root retaining container 20 is smaller than the bottom, the side wall 24 can be removed leaving the base 26, the growing medial and/or plant in the recipient's container. Root retaining containers in which the surplus parts may be removed from the root compatible parts leaving the plant and growing media in the recipient's container are referred to herein as “root adaptable containers”.

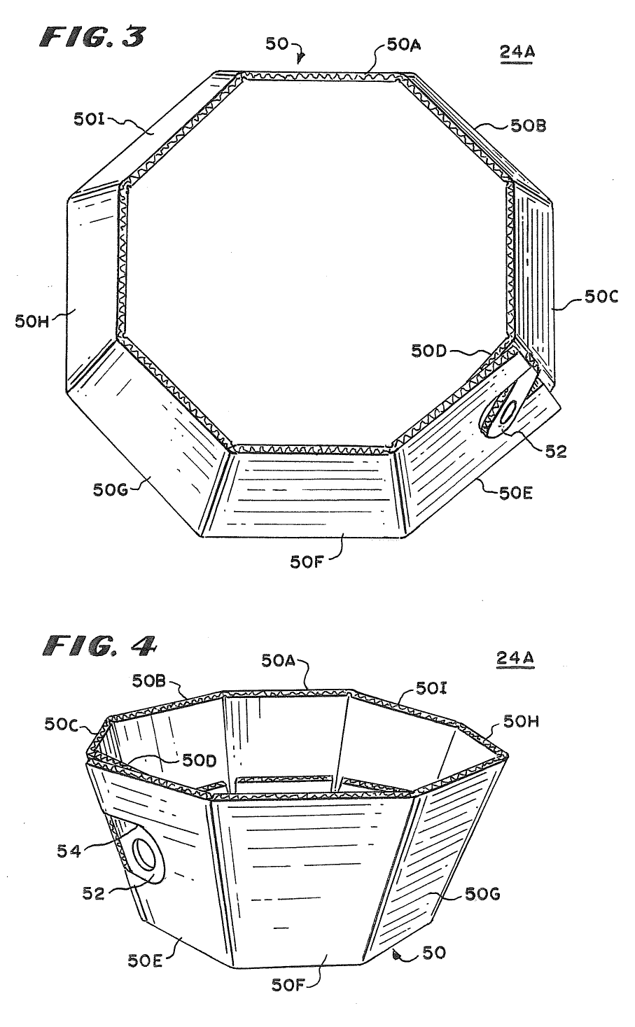

In FIGS. 3, 4 and 5, there are shown a perspective view of a second embodiment of side wall 24A from the side and bottom, a perspective view of the side wall 24A from the top and side and a perspective view directly from the top respectively. In this embodiment, a cardboard elongated strip 50 is die-cut and bent into nine sections 50A-501. Sections 50D and 50E are end sections of the continuous strip 50 and overlap to permit easy fastening together to form a closed surface.

To form a side wall (actually a frustum of an eight sided pyramid), one end section 50D includes a tab 52 and the other end section 50E includes an opening 54 sized to receive the tab 52. The tab 52 cut into the section 50D and the opening 54 in the end section 50E form a fastener to fasten the ends of the strip 50 and form the frustum of a pyramid having eight sides. Of course other fasteners may be used but a tab and an opening are inexpensive and easy to use. With this fastener, the tab may be torn free while the ends 50D and 50E are together so the side wall becomes loose. It may then be removed easily from the recipient's container.

In the preferred embodiment shown in FIGS. 3-16, the base forms the top of the container 20 (FIG. 1) because it is the larger opening with the larger diameter. With a larger top, the bottom may be supported by sizing it to fit within the inverted pyramid. The smaller bottom of the inverted frustum of a pyramid holds the larger bottom of the root retaining container 20. The top and bottom of the container are parallel in the preferred embodiment. In the preferred embodiment, the altitude of the frustum of a pyramid is six inches, at the top the sides of the lateral surfaces are four inches and at the bottom, they are three inches. The diameter of the container at the top is 11 inches and at the bottom it is 7.5 inches.

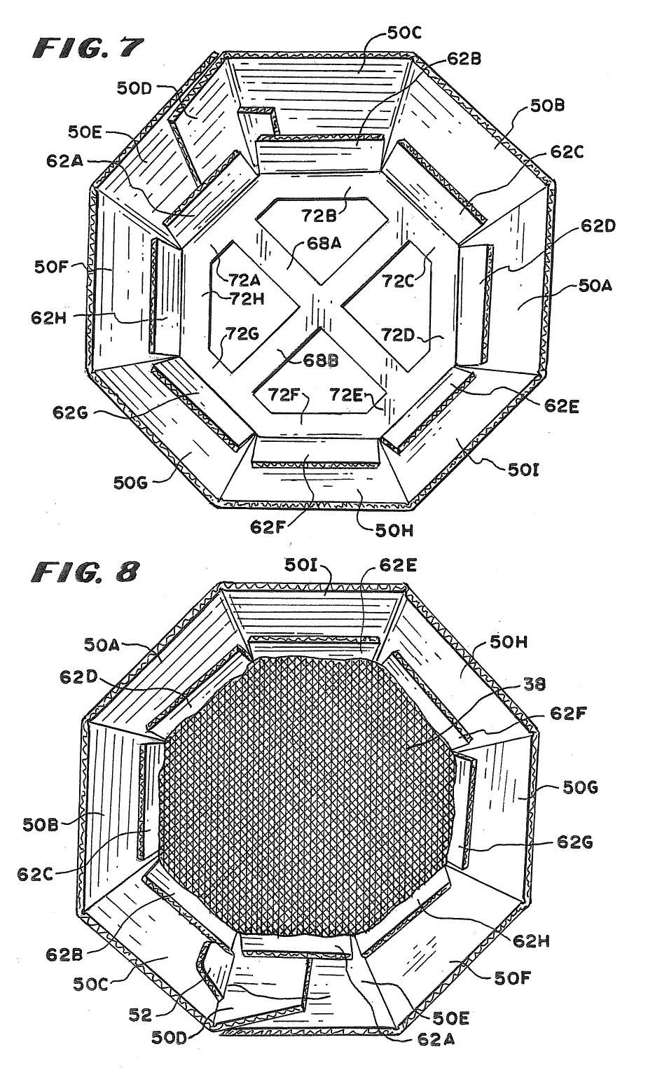

In FIG. 6, there is shown a perspective view of a root compatible bottom 26A having a base section 60 and a side wall section 62. The root compatible bottom 26A has the same general shape as the sections 50A-50H of the side wall 24A of the container 20 (FIGS. 3-5) except that the eight sections of the side wall section 62 are hinged, bent or otherwise flexibly connected to the base and not connected to each other so that they form flaps 62A-62H. With this arrangement, the side wall sections or flaps 62A-62H are able to freely move as flaps connected to the base section 60. When positioned in the container 20 (shown in FIG. 7), the root compatible bottom 26A assumes the shape of an eight sided frustum of a pyramid with a larger open upper side and a smaller bottom side. It is sized to fit within the side wall 24A without falling through the open bottom. With this arrangement, removing the side wall 24A automatically frees the bottom 26A.

The base section 60 of the root compatible bottom 26A serves as the bottom side of the container and is partly open but adapted to be closed by a penetrable or a biodegradable part 38 (shown in FIG. 2). It includes an outer eight sided polygon 72 with each of the eight sides 72A-72H being connected with a flexible connection or by a hinge to a corresponding one of the eight flaps 62A-62H. The eight sided polygon is open in the center except for support members 68A and 68B that extend from one side of the polygon to the other and are perpendicular to each other. The penetrable or biodegradable part 38 (FIG. 1) rests on the support members 68A and 68B.

The flaps 62A-62H sides have an altitude of generally two inches, the base section 60 is generally seven inches from lateral side to lateral side, thus fitting within the side wall 24A of the embodiment of FIGS. 3-5, but not passing through it. With this embodiment, a container can be inexpensively made and assembled for use. The side wall 24A of the container 20 can be easily removed leaving only the root compatible bottom 26A.

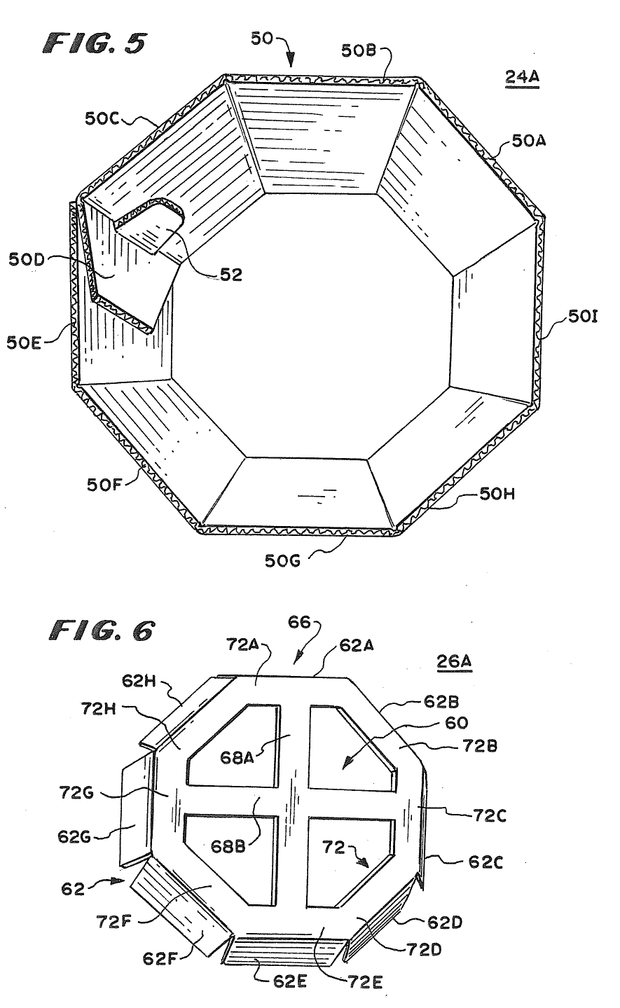

In FIG. 7, there is shown a perspective view looking from the bottom at a container having a side wall 24A as shown in FIG. 5, and a root compatible bottom 26A as shown in FIG. 6 assembled to receive a biodegradable or penetrable root compatible bottom and growing media. In FIG. 8, there is shown a perspective view looking downwardly into the container to see the penetrable or biodegradable root compatible part 38 that overlies the spatial part in the embodiment of FIG. 7. In this view, it is shown ready to receive a plant and growing media. A flag can be positioned with instructions on transplanting.

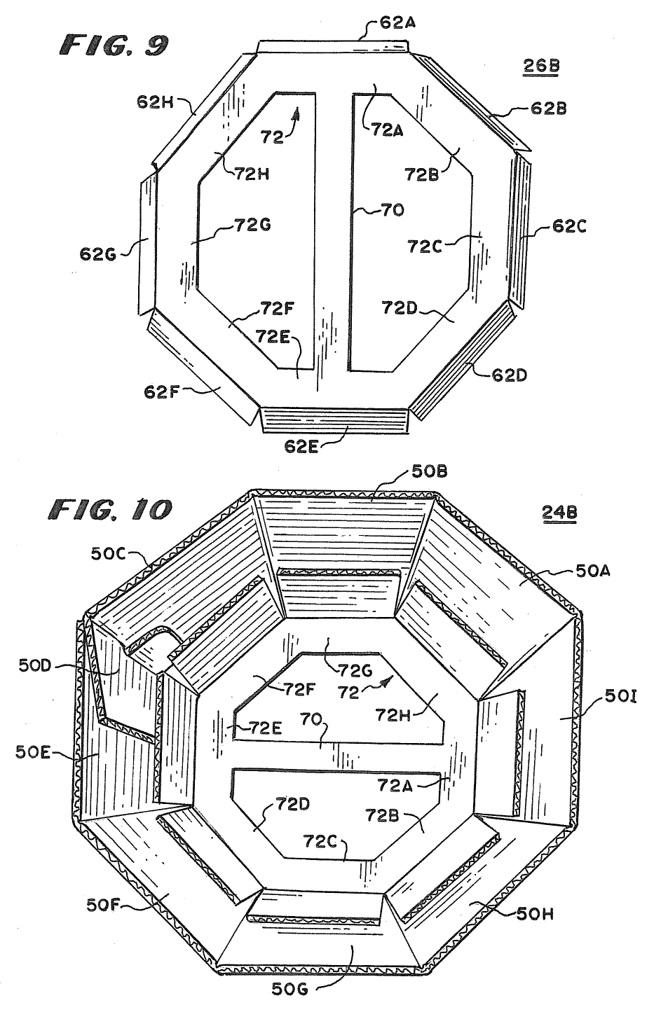

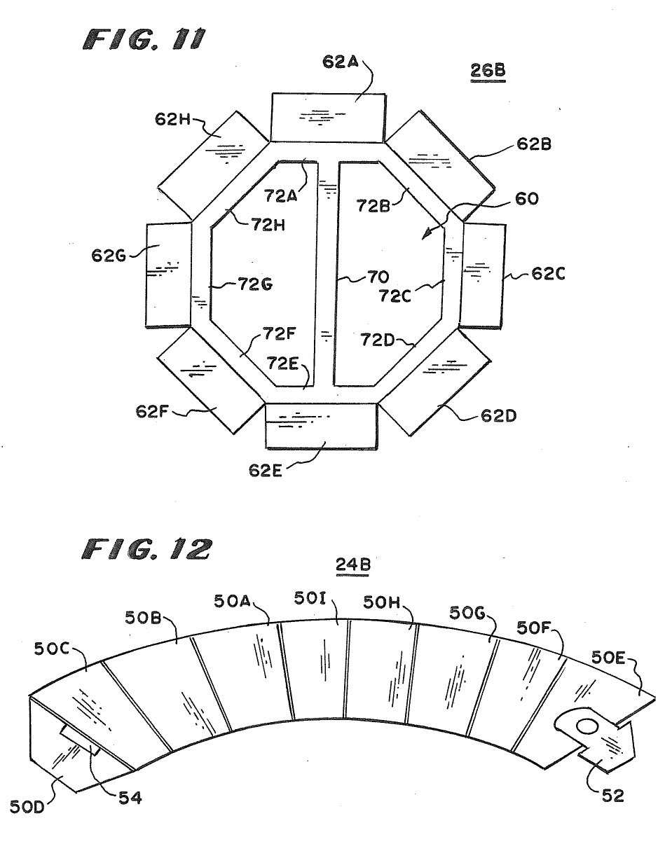

In FIGS. 9 and 10, there are shown respectively a perspective view looking from the bottom and from the top respectively of another embodiment of spatial root compatible bottom 26B and container side wall 24B which may be assembled to form a container in accordance with the invention. The sole difference between the embodiment of FIGS. 7 and 8 and the embodiment of FIGS. 9 and 10 is that the spatial root compatible bottom 26B has a single support member 70 bridging the opening in the center of the polygon 72 instead of having two cross support members 68A and 68B. In FIG. 11, there is shown a plan view of the spatial root compatible bottom 26B with the flaps 62A-62H folded to be in the same plan as the support member 70 in the base section 60. Similarly as shown in FIG. 12, the side wall 24B may be folded flat with each of the sections 50A-501 spread out and a tab 52 in the slot 54 all in the same plane. The penetrable or biodegradable member 38 (FIG. 1) is a flat flexible member so that the three parts that compose the container may each be put in a flattened form for shipment and yet quickly assembled into a container at the greenhouse or nursery.

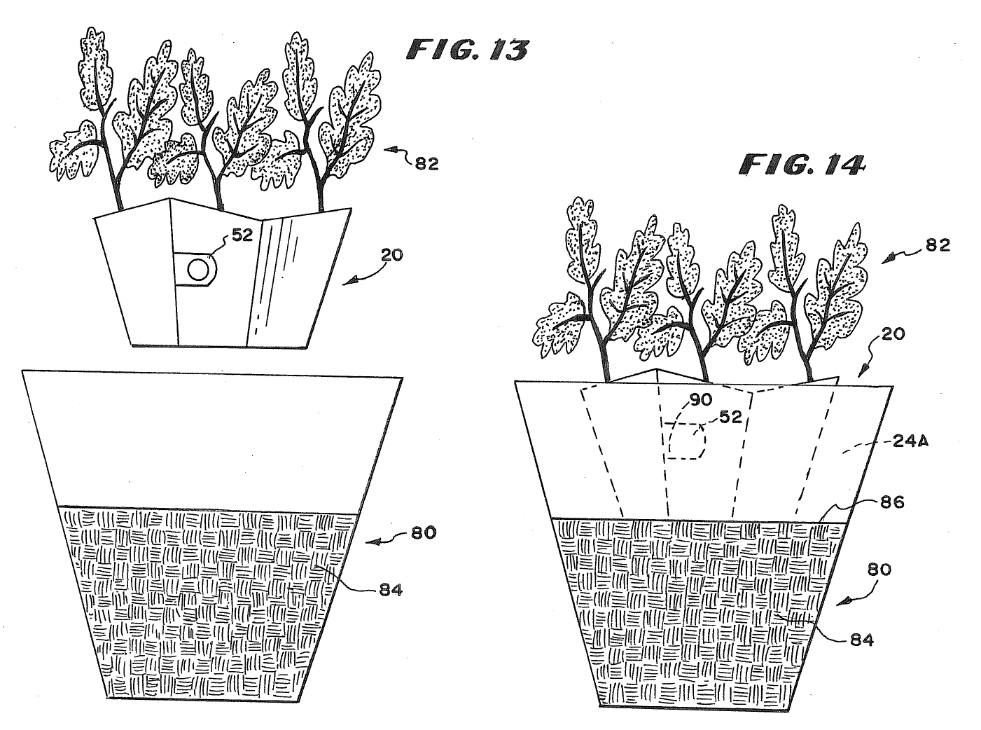

In FIGS. 13, 14 , 15 and 16, there are shown a diagrammatic side view illustrating the insertion of a root retaining container into a recipient's larger container as one stage of the transplanting process, a diagrammatic side view illustrating the removal of the side wall of the root retaining container as a step in the transplanting, a diagrammatic view of a person filling the recipient's container after the root retaining container without the side wall has been placed in it; and a diagrammatic view showing the possible growth of a plant in the recipient's container after transplanting respectively. FIGS. 13, 14, 15 and 16 together provide a developed illustration of the process of transplanting a mature plant 82 from a container 20 to the recipient's container 80. This developed illustration shows how a mature plant 82 within the container 20 may be easily transplanted.

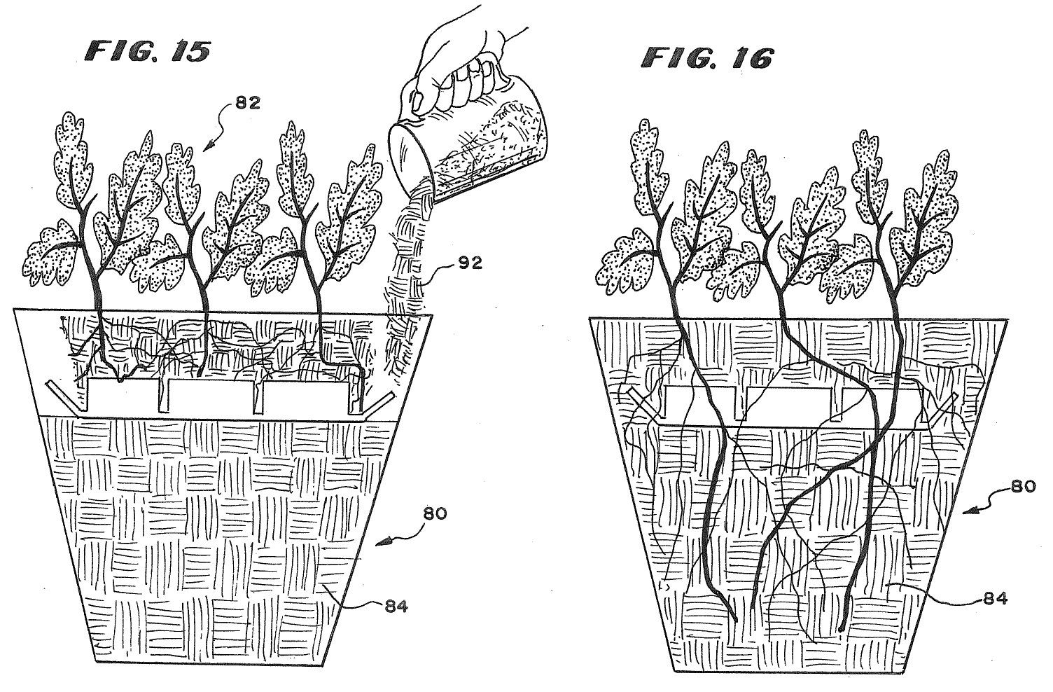

For this purpose, the recipient's container 80 which must be larger than the container 20 is filled with soil 84 to a level 86 of no more than five inches below the top of the pot to accommodate the container 20. The tab 52 of the container 20 is torn off as shown at 90 and the container 20 seated on top of the soil 84 in the container 80. The side wall 24A may then be easily removed as shown in FIG. 14 so that the plant is seated within the container 20. At this time, more soil 84 as shown in FIG. 15 is poured to cover the roots of the plant. The roots of the plant will quickly penetrate the penetrable or biodegradable member as shown in FIG. 16 to be fully transplanted.

This method and apparatus has several advantages, such as for example: (1) they permit the gardener to easily purchase a mature plant and easily transplant it into a selected container; (2) they are inexpensive; and (3) they use parts that can be easily folder or fitted one into the other for inexpensive shipping and yet be quickly assembled into containers by the green house or nursery.

Although an embodiment of the invention has been described with some particularity, many modifications and variations in the preferred embodiment may be made without deviating from the invention. Accordingly, it is to be understood that, within the scope of the appended claims, the invention may be practiced as other than specifically described.

1. A method of transplanting a mature plant to a selected container comprising the steps of:
growing a plant to maturity in a first container, wherein the first container is a root retaining container; and
moving the plant from the first container to a selected container and causing removal of surplus parts of first container from the first container.

2. A method in accordance with claim 1 wherein the step of growing a plant to maturity in a first container includes the step of growing the plant to maturity in a container including a side wall and the step of causing removal of surplus parts includes the step of removing the side wall after the first container has been placed in the selected container.

3. A method in accordance with claim 1 wherein the step of growing a plant to maturity in a first container includes the step of growing the plant to maturity in a container including a continuous side wall and a bottom with the side wall being removable from the bottom and having sections that connect together to form a continuous side wall or separate to permit easy removal of the side wall and the step of causing removal of surplus parts includes the step of disconnecting the sections that are connected together and removing the side wall from the bottom after the first container has been placed in the selected container.

4. A method in accordance with claim 2 wherein the step of causing removal of surplus parts includes the step of forming parts of the container of plant-compatible biodegradable material.

5. A method in accordance with claim 4 wherein the step of forming parts of the container of plant-compatible biodegradable material includes the step of forming the side wall of plant-compatible biodegradable material whereby the side wall will biodegrade without causing root girding.

6. A method in accordance with claim 1 wherein the step of growing a plant to maturity in a first container includes the step of growing the plant to maturity in a container including a bottom wall and the step of causing removal of surplus parts includes the step of removing the bottom wall before the first container is covered with growing media.

7. A method in accordance with claim 1 wherein the step of growing a plant to maturity in a first container includes step of growing the plant to maturity in a container including continuous side wall and a bottom with a bottom wall being removable from the side wall and removing the bottom wall from the side wall before the first container is covered with growing media.

8. A method in accordance with claim 4 wherein the step of forming parts of the container of plant-compatible biodegradable material includes the step of forming a bottom wall of plant-compatible biodegradable material whereby the bottom wall will biodegrade without causing root girding.

9. A method in accordance with claim 2 wherein the side wall has two ends attached to each other further including the step of removing the side wall after the first container has been placed in the selected container and the step of detaching the ends of the side wall from each other.

10. A method in accordance with claim 1 wherein the step of growing a plant to maturity in a first container, wherein the first container is a root retaining container comprises the steps of obtaining and locating component parts of a plurality of stackable first containers in a first location; shipping the component parts of the plurality of stackable first containers to a second location; assembling at least one first container from said plurality of stackable containers, adding growing media to said at least one first container and planting the plant in the growing media.

11. A method in accordance with claim 10 wherein the first container is a root adaptable container and the step of moving the plant from the first container to a selected container and causing removal of surplus parts of the first container from the first container includes the step of removing the surplus parts of the first container while leaving the mature plant in the selected container.

12. A root retaining container for growing a mature plant to be transplanted to a selected container, comprising:
surplus parts; and
root compatible parts.

13. A root retaining container in accordance with claim 12 in which the surplus parts comprise a side wall and the root compatible parts comprise a bottom.

14. A root retaining container in accordance with claim 13 in which the side wall is removable from the bottom.

15. A root retaining container in accordance with claim 14 in which the side wall is a continuous strip that includes end sections which connect together to form a continuous side wall and separate to permit easy removal of the side wall.

16. A root retaining container in accordance with claim 13 wherein the surplus parts comprise plant-compatible biodegradable material.

17. A root retaining container in accordance with claim 16 wherein the plant-compatible biodegradable material degrades prior to root girding.

18. A root retaining container in accordance with claim 17 in which the biodegradable material does not degrade in less than 120 days and degrades in less than one season.

19. A root retaining container in accordance with claim 12 wherein the surplus parts are a bottom.

20. A root retaining container in accordance with claim 12 wherein the container includes a continuous side wall and a bottom with a bottom wall being removable from the side wall.

21. A root retaining container in accordance with claim 20 wherein the bottom wall is formed of plant-compatible biodegradable material whereby the bottom wall will biodegrade without causing root girding.

22. A root retaining container in accordance with claim 12 wherein the surplus parts and root compatible parts may be folded to be flat for easy shipment.

23. A root retaining container in accordance with claim 12 wherein a plurality of surplus parts fit one into the other.

24. A root retaining container in accordance with claim 12 wherein a plurality of root compatible parts fit one into the other.

25. A root retaining container in which a surplus part includes a strip of foldable material having two end sections that may be connected together to form a hollow inverted pyramid with a root compatible part of similar shape sized to fit within the surplus part without falling out.
